(19) United States
(12) Patent Application Publication
(10) Pub. No.: US 2021/0099608 A1
(43) Pub. Date: Apr. 1, 2021

(54) SYSTEM, IMAGE COMMUNICATION DEVICE, AND COMMUNICATION METHOD OF IMAGE COMMUNICATION DEVICE

(71) Applicant: SHARP KABUSHIKI KAISHA, Osaka (JP)

(72) Inventors: SHO KAMIHISA, Osaka (JP); AKINORI OHNISHI, Osaka (JP)

(21) Appl. No.: 17/035,576

(22) Filed: Sep. 28, 2020

(30) Foreign Application Priority Data
Sep. 30, 2019 (JP) 2019-180143

(51) Int. Cl. H04N 1/327; H04N 1/32

(52) U.S. Cl. CPC H04N 1/32769; H04N 1/32739; H04N 1/32767; H04N 1/32128

(57) ABSTRACT

An image communication device transmits, to a server device, a first image based on a received image and communication information at a tune when the image is received. A terminal device receives the first image and the communication information from the server device, displays the first image together with the communication information, and transmits a reply command to the server device, based on an operation of a user. The image communication device transmits a second image to a destination included in the communication information, if the image communication device receives the reply command from the server device.

### BACKGROUND OF THE INVENTION

### Field of the Invention

The present invention relates to a system and the like including an image communication device that transmits and receives an image, a server device capable of communicating with the image communication device, and a terminal device capable of communicating with the server device. This Nonprovisional application claims priority under 35 U.S.C. § 119(a) on Patent Application No. 2019-180143 filed in Japan on 30 Sep. 2019, the entire contents of which are hereby incorporated by reference.

### Description of the Background Art

Conventionally, an invention is known in which a facsimile device, being an image communication device, performs notification in a case of receiving a facsimile.

For example, a technique is disclosed in which if receiving a facsimile, an image forming apparatus acquires transmission source information of the facsimile, searches a notification destination address of a notification destination that is to be notified of the reception of the facsimile from storage that associate and manage transmission source information and the notification destination address, creates a notification message to perform notification of the reception of the facsimile to the notification destination address, and transmits the notification message to the notification destination by using a predetermined protocol (see Japanese Unexamined Patent Application Publication No. 2008-160531).

If a reception notification of a facsimile is received, it is not easy to transmit a reply to the facsimile in a case where a reply to the facsimile is desired. For example, a user needs to separately create a text stating that the facsimile is received, and needs to perform an operation for transmitting the created text by facsimile.

To solve the problems described above, an object of a system according to the present invention is to provide a system and the like capable of easily executing a reply process if an image is received by an image communication device.

### SUMMARY OF THE INVENTION

A system according to the present embodiment includes an image communication device that transmits and receives an image, a server device that communicates with the image communication device, and a terminal device that communicates with the server device,

the image communication device
transmits, to the server device, a first image based on a received image and communication information at a time when the image is received,

the terminal device:
receives the first image and the communication information. from the server device;
displays the first image together with the communication information; and
transmits a reply command to the server device, based on an operation of a user, and

the image communication device transmits a second image to a destination included in the communication information, if the image communication device receives the reply command from the server device.

An image communication device according to the present embodiment

is connectable to a server device that communicates with a terminal device and includes

a first communicator that transmits, to the server device, a first image based on a received image and communication information at a time when the image is received, and

a second communicator that transmits a second image to a destination included in the communication information, if a reply command transmitted from the terminal device to the server device is received from the server device.

A communication method of an image communication device according to the present embodiment

is a communication method of an image communication device connectable to a server device that communicates with a terminal device, and the communication method includes

transmitting, to the server device, a first image based on a received image and communication information at a time when the image is received, and

transmitting a second image to a destination included in the communication information, if a reply command transmitted from the terminal device to the server device is received from the server device.

According to a system of the present invention, a user can easily execute a reply process if an image is received by an image communication device or the like.

### BRIEF DESCRIPTION OF THE DRAWINGS

FIG. 1 is a diagram for describing an overview of a system according to a first embodiment;

FIG. 2 is a diagram for describing a functional configuration of an image communication device and a server device according to the first embodiment;

FIG. 3 is a diagram for describing a functional configuration of a terminal device according to the first embodiment;

FIG. 4 is a diagram for describing history data according to the first embodiment;

FIG. 5 is a diagram for describing a process in the first embodiment;

FIG. 6 is a diagram for describing an operation example in the first embodiment;

FIG. 7 is a diagram for describing an operation example in the first embodiment;

FIG. 8 is a diagram for describing an operation example in the first embodiment;

FIG. 9 is a diagram for describing a process in a second embodiment;

FIG. 10 is a diagram for describing a process in the second embodiment;

FIG. 11 is a diagram for describing an operation example in the second embodiment;

FIG. 12 is a diagram for describing a process in a third embodiment;

FIG. 13 is a diagram for describing an operation example in the third embodiment;

FIG. 14 is a diagram for describing an operation example in the third embodiment;

FIG. 15 is a diagram for describing an operation example in the third embodiment; and

FIG. 16 is a diagram for describing an operation example in a fourth embodiment.

### DESCRIPTION OF THE PREFERRED EMBODIMENTS

Below, an embodiment to which a system of the present invention is applied will be described. It is noted that each of the embodiments is used for the convenience of describing the present invention, and the technical scope of the present invention is not limited to the following embodiments.

### 1. First Embodiment

### 1.1 Overall Configuration

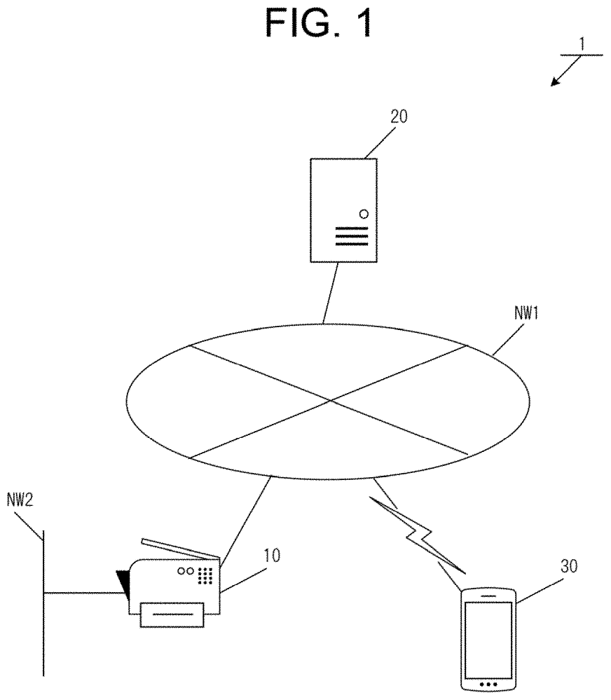

FIG. 1 is a diagram for describing an overview of a system 1. In the system 1, an image communication device 10, a server device 20, and a terminal device 30 are connected via a network NW1.

The image communication device 10 includes at least a facsimile (FAX) function. The image communication device 10 may be mounted in an image forming apparatus such as a multi-function peripheral (MFP), or may be a stand-alone device. The image communication device 10 can also be connected to a network NW2 of a telephone line such as an analog line or a digital line (ISDN).

The server device 20 is a device that provides a predetermined service. The server device 20 may be a stand-alone server device or a plurality of server devices may provide each service. The server device 20 and the image communication device 10 are described as separate devices. However, a server function may also be implemented in the image communication device 10, for example.

Here, services provided by the server device 20 include, for example, the following services.
Acquisition of a state of the image communication device 10 (for example, job information, a state of a sheet, error history, and the like) and providing the state to a user
Transmission and reception of an image utilizing facsimile communication of the image communication device 10
Access to a Network Attached Storage (NAS) and a file server to manage a file
User schedule management, meeting reservation management, meeting hosting, and the like
Acquisition of a state and the like of another image communication device connected to the network

The terminal device 30 is a device used by a user. The terminal device 30 according to the present embodiment is realized by installing an application in a general terminal device, for example. The terminal device 30 is an information processing device such as a smartphone, a smartwatch, a tablet, or a computer, but may also be a device such as a car navigation system or a home appliance capable of executing the application, for example.

The network NW1 connects each of the devices. For example, the network NW1 is realized by a Local Area Network (LAN) or a Wide Area Network (WAN). The network NW1 may be configured by combining these networks.

In the present specification, “receive a FAX” and “reception of a FAX” mean that the image communication device 10 utilizes facsimile communication to receive an image based on a standard. “Transmit a FAX” and “transmission of a FAX” mean that the image communication device 10 utilizes facsimile communication to transmit an image based on a standard. Facsimile communication is electric communication in which an image including a character, a figure, and the like is transmitted and received, and a transmission path provided to be used for the facsimile communication is called a facsimile communication network. The term “received FAX” refers to an image received by the image communication device 10 from another device by utilizing facsimile communication.

### 1.2 Device Configuration

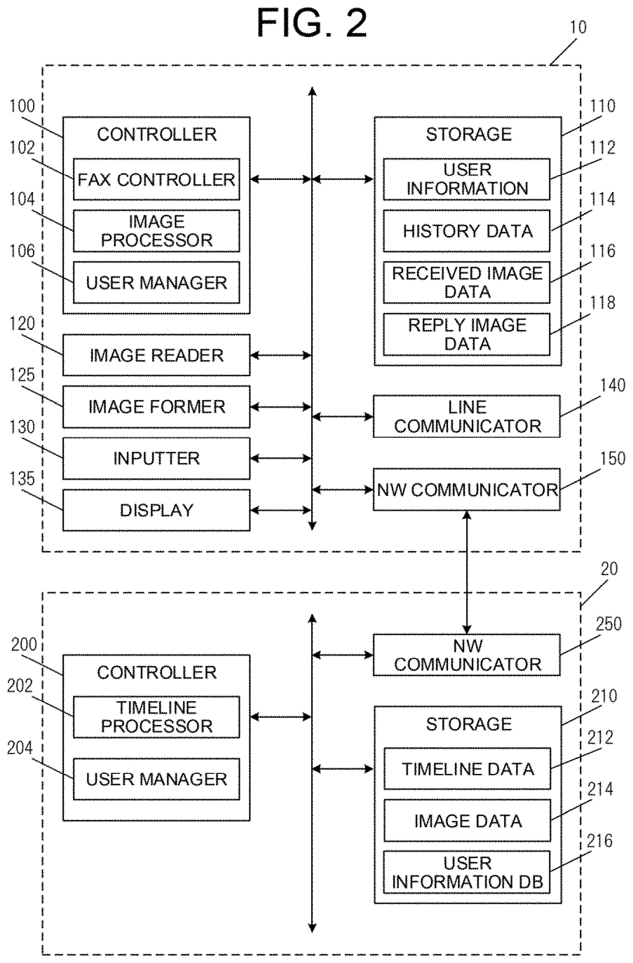

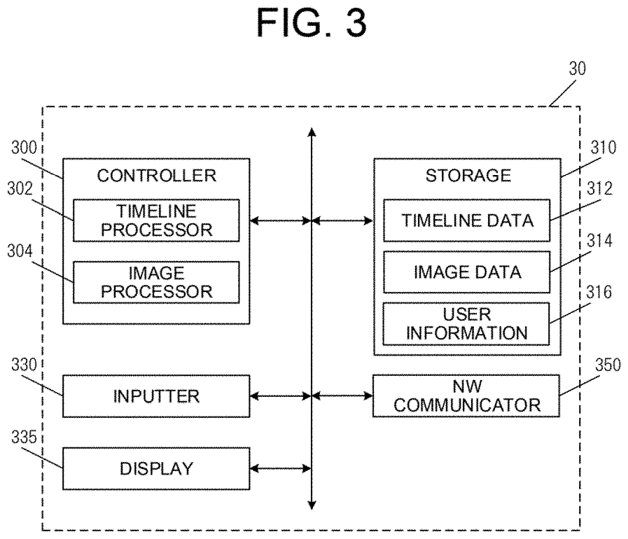

Next, a configuration of each of the devices will be described. FIG. 2 is a diagram for describing configurations of the image communication device 10 and the server device 20, and FIG. 3 is a diagram for describing a configuration of the terminal device 30. It is sufficient that the configuration of each of the devices includes a component necessary for an operation, and the described configurations are not imperative configurations.

A function of the server device 20 may be realized in the image communication device 10, and a function provided by the server device 20 may utilize a chat service or an SNS service provided by an external service.

A common configuration will be described below. Here, for each functional element, an appropriate performance, size, configuration, and device are selected for each device, and the functional elements do not necessarily have the same configuration.

A controller (controller 100, controller 200, controller 300) is a functional element that entirely controls each device. The controller realizes various types of functions by reading and executing various types of programs stored in a storage of each device, and includes one or a plurality of arithmetic devices (for example, a central processing unit (CPU)).

The storage (storage 110, storage 210, storage 310) is a functional element that stores various types of programs and various types of data necessary for an operation of each device. The data stored in the storage includes temporarily stored data and data that is held as necessary. The storage includes, for example, a Solid State Drive (SSD) being a semiconductor memory, and a Hard Disk Drive (HDD). The various types of data may be stored in a storage area on a cloud, instead of the storage.

An inputter (inputter 130, inputter 330) receives an operation input from a user. For example, the inputter is configured by a capacitive type or resistive type touch panel. The inputter may be a combination of a touch panel and an operation pen, or may be an input device such as a keyboard or a mouse.

A display (display 135, display 335) displays various types of information. For example, the display is configured by a liquid crystal display, an organic EL display, an LED display, or the like. In the present embodiment, displaying is a concept including projection by a projector and the like, and the display includes a projection device.

A communicator communicates with another device. For example, the communicator connects to a Local Area Network (LAN) to transmit and receive information to and from the other device, and transmit and receive an image to and from the other device. In the present embodiment, the communicator includes an NW communicator (NW communicator 150, NW communicator 250, NW communicator 350) that utilizes, as a communication scheme, a LAN being a general Ethernet (registered trademark) or a communication scheme such as Long Term Evolution (LTE)/4G/5G, and a line communicator (line communicator 140) capable of communicating with a telephone line. The communicator also functions as a transmitter that transmits data, an image, and the like, and a receiver that receives data, an image, and the like.

### 1.2.1 Image Communication Device

As illustrated in FIG. 2, the image communication device 10 includes the controller 100, the storage 110, an image reader 120, an image former 125, the inputter 130, the display 135, the line communicator 140, and the NW communicator 150.

By executing a program, the controller 100 functions as a FAX controller 102, an image processor 104, and a user manager 106.

The FAX controller 102 performs FAX transmission and FAX reception. For example, the FAX controller 102 transmits an image of a document read by the image reader 120, from the line communicator 140 to another device via a telephone line. In the case of Internet FAX, the FAX controller 102 transmits an image from the NW communicator 150 to another device via the Internet.

That is, the FAX controller 102 performs facsimile communication utilizing the normal G3/G4 standard or the like or facsimile communication utilizing the Internet FAX to transmit and receive an image to and from another device. The FAX controller 102 may perform facsimile communication utilizing any known standard or protocol.

Here, the FAX controller 102 receives an image based on a facsimile communication signal received from the line communicator 140 or the NW communicator 150, and stores the image as received image data 116 in the storage 110. The image received by the FAX controller 102 is referred to as a “received image”.

The image processor 104 performs a process regarding various types of images. For example, the image processor 104 executes a sharpening process and a gradation conversion process for an image read by the image reader 120. Further, the image processor 104 combines text and one or a plurality of images to generate an image to be transmitted by the FAX controller 102.

The user manager 106 manages a user utilizing the image communication device 10 and the system 1. For example, the user manager 106 executes user authentication based on a user name and a password stored in user information 112. Further, the user manager 106 executes a process to perform log in/log out to a service provided by the server device 20.

The storage 110 stores the user information 112, history data 114, the received image data 116, and reply image data 118.

In the user information 112, information about the user is stored. For example, in the user information 112, a login ID, a password, a name, and the like of each user are stored as information for identifying the user. The user manager 106 executes user authentication based on the login ID and the password stored in the user information 112.

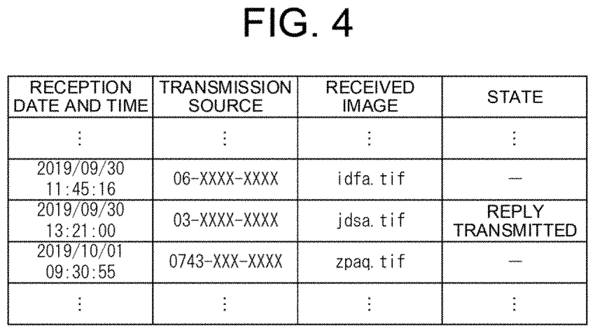

In the history data 114, information about a history (history information) such as a communication history of the image communication device 10 and a job history is stored. For example, an example of the history data 114 is illustrated in FIG. 4. The history data 114 includes a date and time when the FAX is received (for example, “2019/09/30 11:45:16”), information about a transmission source (sender) of the received FAX (for example, “06-XXXX-XXXX” indicating a telephone number), a received image (for example, “idfa.tit” as a an image file of tiff format), and a state (for example, a flag indicating whether a reply is transmitted).

Here, the information about the transmission source (sender) is information included in a protocol in the facsimile communication, a telephone number transmitted by a transmission telephone number notification service, information designated by the sender, and the like. For example, in the case of the G3 protocol, the FAX controller 102 acquires a transmission terminal identification number (Transmitting Subscriber Identification (TSI)) and stores the transmission terminal identification number as information of the transmission source.

As the received image, information indicating the received image (for example, a file name of the image) is stored. The image received by the FAX controller 102 is stored in the received image data 116, but may also be included in the history data 114.

As the state, a state related to the facsimile communication is stored. For example, data indicating that transmission is not possible due to an error, data indicating that transmission reservation is performed, data indicating that a reply process for an image received by the facsimile communication is completed, and the like are stored. It is sufficient that the history data 114 includes necessary information as the state. Therefore, information about the state that is not utilized in the system 1 may not be stored.

The received image data 116 stores an image received by the FAX controller 102 by using facsimile communication. In the reply image data 118, an image (hereinafter, appropriately referred to as a “reply image”) transmitted by the FAX controller 102 during a reply process by using facsimile communication is stored.

The image reader 120 reads a document and outputs image data. For example, the image reader 120 uses a CCD scanner to read a document placed on a document platen of the image communication device 10 and outputs an image. The image reader 120 stores the image in the storage 110. For example, the image reader 120 is configured by a scanner device or the like, but may also read an image stored in a USB flash drive, for example.

The image former 125 forms an image on a recording paper, for example. That is, the image is printed on the recording paper by the image former 125. For example, the image former 125 is configured by a laser printer or the like.

### 1.2.2 Server Device

As illustrated in FIG. 2, the server device 20 includes the controller 200, the storage 210, and the NW communicator 250.

By executing a program, the controller 200 functions as a timeline processor 202 and a user manager 204.

The storage 210 stores timeline data 212, image data 214, and a user information DB 216.

The timeline processor 202 utilizes a timeline to process messages transmitted from and received by a user utilizing the terminal device 30. The timeline is used for displaying a message, an image, and the like arranged in chronological order. For example, messages received from each user and from each device are arranged unidirectionally in chronological order on the same screen. By checking the timeline, the user can easily check the messages in chronological order. Here, the timeline processor 202 may generate a timeline screen that displays messages. If a timeline processor 302 of the terminal device 30 generates a timeline screen, information necessary for generating the timeline screen (for example, a message to be displayed, posting date and time, an attribute, and the like) is transmitted to the terminal device 30. That is, in the present embodiment, the timeline may be displayed on the terminal device 30.

The timeline processor 202 stores the timeline data 212 in the storage 210 as data necessary for generating the timeline. In the timeline data 212, for example, a poster of a message (posting source, posting destination), the posting date and tune, and a posted message are stored. The timeline may be stored for each user or for each group.

The timeline processor 202 performs a process that can generally be realized on the timeline. For example, it is possible to display a message received from each user, perform a bookmark registration process, a reply operation, image transmission and reception, and management for each user group.

The user manager 204 performs user authentication and user management. For example, the user manager 204 authenticates a user utilizing the timeline so that a correctly authenticated user can utilize a service. Information of each user is stored in the user information DB 216. The user information DB 216 stores, for example, a user name, a password, a login date and time, and the like.

Various types of images are stored in the image data 214. For example, various images such as an image displayed on the timeline and a received image received by FAX are stored.

### 1.2.3 Terminal Device

As illustrated in FIG. 3, the terminal device 30 includes the controller 300, the storage 310, the inputter 330, the display 335, and the NW communicator 350.

By executing a program, the controller 300 functions as the timeline processor 302 and an image processor 304.

The timeline processor 302 displays a timeline on the display 335 of the terminal device 30 and executes a process related to the timeline. For example, the timeline processor 302 posts a message on the timeline or displays a message stored in timeline data 312 on the timeline. The timeline processor 302 performs a process that can generally be realized on the timeline. For example, the timeline processor 302 is capable of executing a process such as bookmarking a message, a user, an image, and the like displayed on the timeline, editing and deleting a posted message, uploading an image, and transmitting a command utilizing a selection button.

The image processor 304 executes a general image process. For example, the image processor 304 executes a process such as display enlarging/reducing, performing display for each page, performing page switching display, and performing display of a plurality of pages, based on the received image. The image processor 304 may generate and display a thumbnail image or a preview image of an image received from the server device 20.

The storage 310 stores the timeline data 312, image data 314, and user information 316.

In the timeline data 312, a message and control information regarding the timeline processed by the timeline processor 302 are stored. For example, information received from the server device 20 and utilized when the timeline processor 302 displays the timeline is stored. A message to be transmitted to the server device 20 and control information (for example, information for identifying a message bookmarked, information about an image to be uploaded, and the like) may be stored together. If a timeline screen is received from the server device 20, information about the timeline screen (for example, HTML or XML) is stored in the timeline data 312.

The image data 314 stores image data to be transmitted to another device or image data received from another device. For example, the timeline processor 302 stores an image received from the server device 20 (image displayed on the timeline) in the image data 314. The server device 20 stores, in the image data 314, an image uploaded by the terminal device 30 to the timeline.

In the user information 316, information about a use utilizing the terminal device 30 is stored. For example, the terminal device 30 stores user information for utilizing a service of the server device 20 and user information for logging in to the image communication device 10.

### 1.3 Process Flow

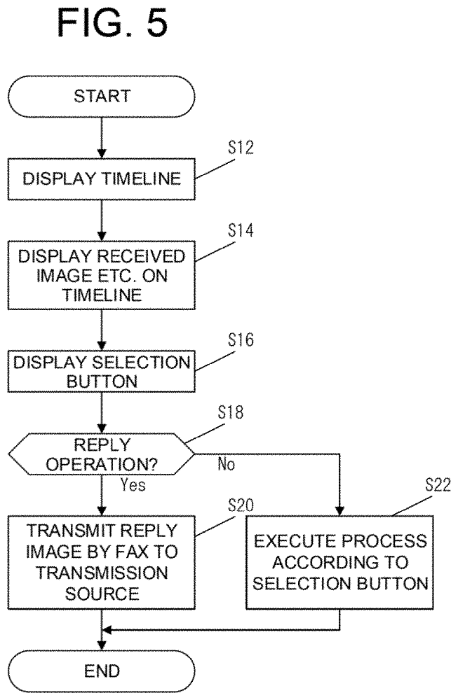

A flow of processing of the present embodiment will be generally described. FIG. 5 is a flowchart for describing an outline of an entire system.

First, the controller 300 (timeline processor 302) of the terminal device 30 displays the timeline on the display 335 (step S12). For example, the terminal device 30 displays the timeline by executing a dedicated application in the terminal device 30 or an application connected to a chat service. In the timeline, messages are displayed in chronological order.

The timeline screen may be generated by the server device 20 or the terminal device 30. In other words, it is only required that the timeline screen is displayed on the display 335 of the terminal device 30.

In the timeline, one or a plurality of users can post/display a message. Further, one or a plurality of image communication devices can post a message in the timeline. That is, the user (terminal device 30) and the image communication device 10 may be in a one-to-one relationship, or the user and the image communication device 10 may be in a many-to-one relationship. Alternatively, a plurality of the image communication devices 10 may be provided, and thus, the user and the image communication device 10 may be in a one-to-many or in a many-to-many relationship.

Here, if receiving a FAX, the image communication device 10 transmits the received image and communication information at the time of reception as a message to the server device 20. The image communication device 10 may transmit all images received first, or may transmit a thumbnail image for one page.

Here, the communication information includes, for example, the following information.
Sender information (telephone number, name, email address, IP address, and the like of the sender)
Image name (text name, file name, and the like)
File size of the image
Number of pages of the image (for example, in the case of a PDF or TIFF file, number of pages of a text and an image included in the file)
Reception date and time when the image is received by the image communication device 10

The image communication device 10 transmits the received image and the communication information as a message to the server device 20. The server device 20 generates a message based on the received image and the communication information, and posts the message on the timeline. At this time, the image communication device 10 may transmit a thumbnail image of the received image.

As a result, the received image and the communication information are displayed on the timeline (step S14). Here, an image displayed on the timeline is preferably a thumbnail image of one page of the received image. The image of the one page may be, for example, the first page of the image, or a page other than a cover page (for example, the second page) may be displayed.

Here, the thumbnail image is a reduced image displayed for checking the image. The image may be reduced each time and displayed, or a thumbnail image may be utilized that is generated and stored separately from the image.

A selection button is also displayed on the timeline of the terminal device 30 (step S16). Here, if the user performs an operation of selecting a reply selection button (step S18; Yes), the image communication device 10 transmits a reply image by FAX to the transmission source (step S20). In the present embodiment an operation in which the user selects the reply button is referred to as a reply operation.

For example, if the reply operation is performed by the user, the terminal device 30 transmits a command (hereinafter, referred to as a “reply command”) indicating a content of the reply to the image communication device 10 via the server device 20. The reply command may be, for example, information that is transmitted from the terminal device 30 and is different from the message, or may be a message indicating a content of the reply. If the reply command is a message, the reply command may be displayed on the timeline. If the reply command is information different from the message, the terminal device 30 (controller 300) may transmit the reply command to the image communication device 10 via the server device 20, or may transmit the reply command directly to the image communication device 10.

If receiving the reply command, the image communication device 10 generates a reply image. Then, the FAX controller 102 of the image communication device 10 transmits the reply image by FAX to a sender identified from the communication information (step S20). A case where the image communication device 10 (image processor 104) generates the reply image will be described. However, the reply image may be generated by the terminal device 30 or the server device 20. In this case, the image communication device 10 transmits the reply image transmitted from the terminal device 30 or the server device 20 by FAX (step S20).

If the user selects another selection button, another process may be executed (step S22). Here, the other process includes, for example, the following processes.
A mail transfer process for transferring a received image to an email address
A list display process for displaying a list of images received so far
An image display process for enlarging an image displayed on the timeline
A download process for downloading all images received so far or an image included in a specified time period

### 1.4 Operation Example

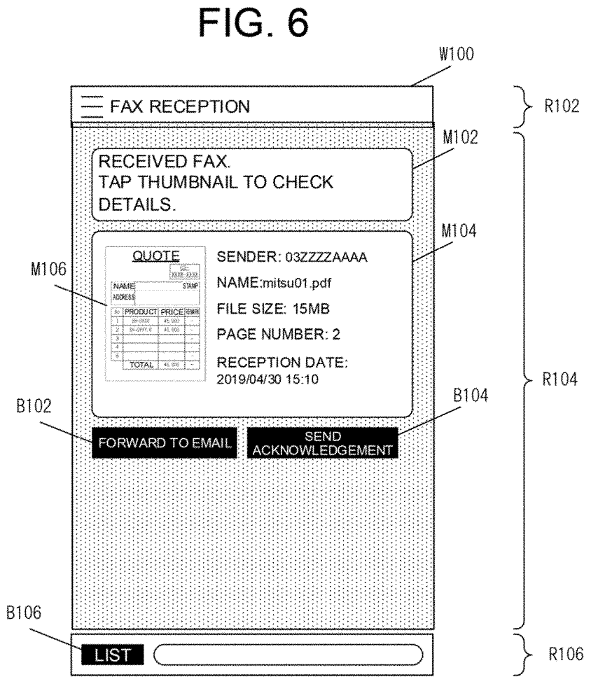

FIG. 6 is a diagram illustrating an example of a display screen W100 displayed on the display 335 of the terminal device 30. The display screen W100 is divided into a processing region R102 being a first region, a timeline region R104 being a second region, and an operation region R106 being a third region.

The processing region R102 is a region displayed by a general application, and is a region capable of displaying, for example, a title of an application, a content of an actual process, an alert content, and the like. A menu display region is secured in a part of the processing region R102 (for example, near a left edge in FIG. 6). For example, if the user selects (for example, touches or taps) the menu display region, the terminal device 30 displays a menu or executes a process selected from the menu by the user.

The timeline region R104 displays a timeline that displays messages in chronological order. For example, in FIG. 6, the terminal device 30 sequentially displays new messages from top to bottom. It is noted that new messages may be displayed from bottom to top, or a plurality of columns may be displayed.

The operation region R106 is a region that receives an operation input by the user. For example, if a message is input in a text box, the terminal device 30 transmits the message to the server device 20 and the timeline is updated. Various types of buttons may he displayed in the operation region R106. For example, buttons corresponding to operations such as a message transmission button and a timeline switching button are displayed. FIG. 6 illustrates a list button B106 for performing a list display described later.

In FIG. 6, the terminal device 30 displays the timeline in the timeline region R104 of the display screen W100. If the terminal device 30 receives a new message from the server device 20, the terminal device 30 displays the new message in chronological order on the timeline.

If the image communication device 10 receives a FAX (receives an image by facsimile communication), the image communication device 10 notify the server device 20 of the reception of the FAX. That is, the reception of the FAX is posted as a message.

The message about the reception of the FAX is displayed on the timeline displayed by the terminal device 30. The timeline can be displayed on a plurality of the terminal devices 30. Therefore, a plurality of users can check the timeline to confirm that the FAX has been received by the image communication device 10.

Referring to FIG. 6, a message M102 indicating that the FAX is received by the image communication device 10 is displayed on the timeline. A message including a thumbnail image of the received image and communication information is displayed as a message M104 on the timeline.

A selection button that prompts the user to perform a process is displayed on the timeline. For example, the timeline processor 302 of the terminal device 30 (or the timeline processor 202 of the server device 20) displays a selection button B102 and a selection button B104 on the timeline.

If the selection button B102 is selected by the user, the controller 300 of the terminal device 30 transfers the image received by the image communication device 10 by email. In this case, the controller 300 causes the display screen to transition from the timeline to a mail creation screen. If the image is not downloaded at this time, the terminal device 30 downloads the image and attaches the image to the email.

If the user selects the selection button B104, the controller 300 executes a reply process to a sender displayed in the message. That is, the terminal device 30 transmits a reply command to the image communication device 10. If receiving the reply command, the image communication device 10 transmits a reply image by FAX to the sender. If the user selects an image M106 representing a thumbnail image, the terminal device 30 displays a preview of an image corresponding to the thumbnail image.

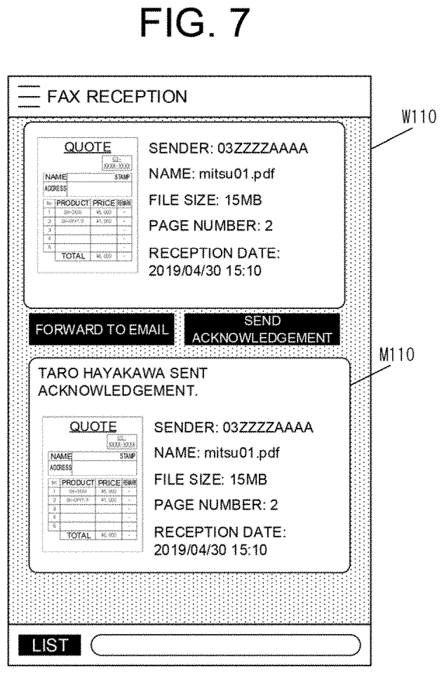

The display screen W110 of FIG. 7 displays a timeline in a case where the image communication device 10 has executed the reply process. In the timeline, a message M110 indicating that the image communication device 10 has transmitted the reply image to the transmission source is displayed.

In the display screen W110 of FIG. 7, the selection button remains displayed on the timeline. However, the controller 300 (timeline processor 302) may delete the selection button from the timeline after executing the process.

A message indicating that the reply image has been transmitted to the transmission source is displayed in the timeline, and thus, by checking the same timeline, another user can also easily confirm that a reply has been transmitted to the transmission source.

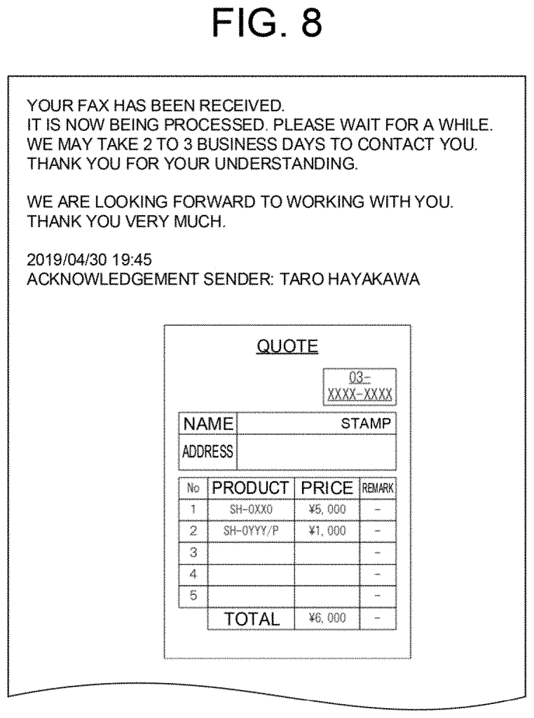

FIG. 8 is a diagram illustrating an example of the reply image. The image communication device 10 transmits the reply image to another device (for example, another image communication device). In the other device, the reply image is printed on a recording paper and output, for example.

The reply image in FIG. 8 is generated so as to include a message for the reply and a part of the received image (for example, the first page). Since the received image (or a part of the received image) is included in the reply image, the sender can surely confirm that the FAX has been received.

Here, the reply image illustrated in FIG. 8 is generated based on a template set in advance. The image communication device 10 may generate the following reply images, for example.
Generation of a reply image by including only a part of the received image such as an upper half or one-third of the received image in the reply message set in advance
Generation of a reply image by using a text input by the user as a reply message
Generation of a reply image by synthesizing a reply image in which a message such as “Received” or an image such as “Received” is superimposed on the received image

As described above, according to the present embodiment, if the image communication device 10 receives a FAX, the fact that the FAX is received and a thumbnail image of the received image are displayed on the timeline displayed on the terminal device 30. In addition, an operation of replying to the transmission source of the image displayed on the timeline can be easily performed on the terminal device 30.

### 2. Second Embodiment

A second embodiment will be described. In the second embodiment, in addition to processes of the first embodiment, management is easily performed when a FAX is received and a reply operation is performed. The system configuration and the device configuration are the same as those in the first embodiment, and thus, aspects different from the first embodiment will be mainly described. In the second embodiment, a process of the image communication device 10 and a process of the terminal device 30 will be described separately. However, needless to say, the processes are executed in each of the devices, similarly to the first embodiment.

### 2.1 Process Flow

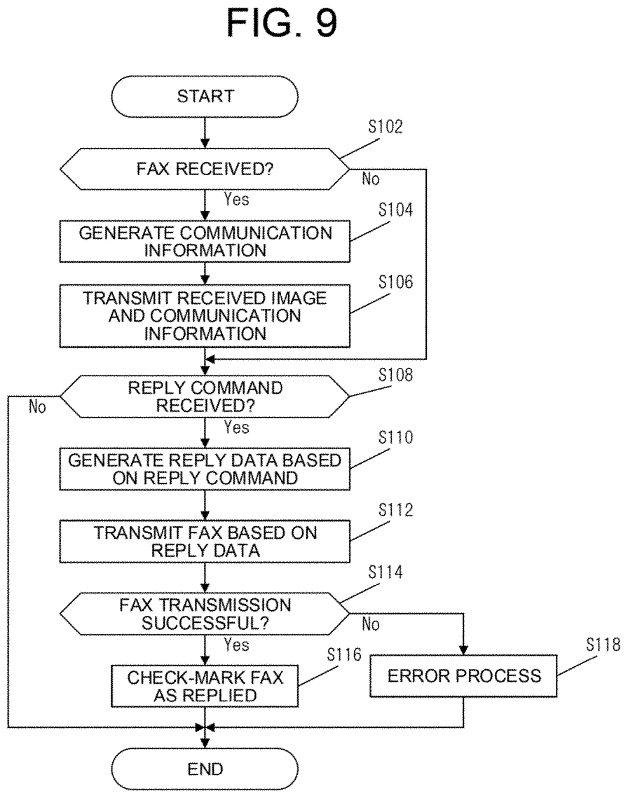

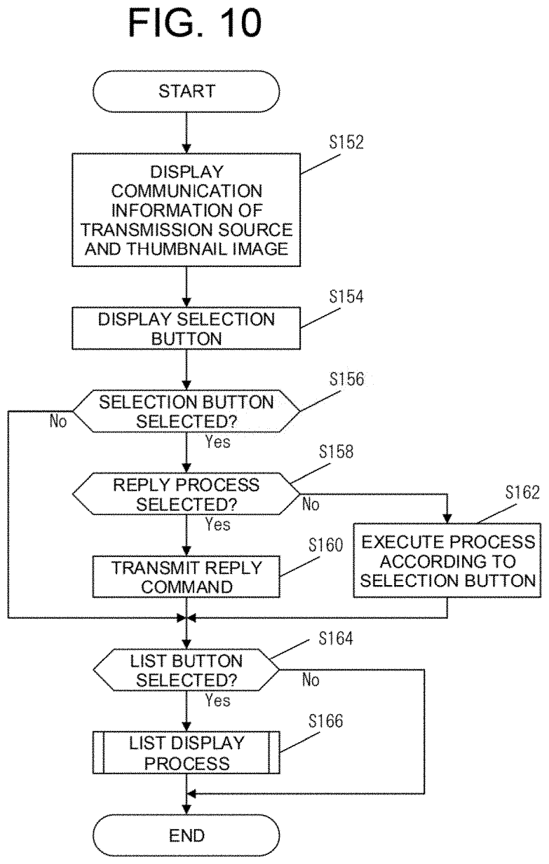

A process flow of the second embodiment is illustrated in FIGS. 9 and 10. FIG. 9 illustrates a process executed by the image communication device 10 (controller 100), and FIG. 10 illustrates a process executed by the terminal device 30 (controller 300).

### 2.1.1 Process of Image Communication Device

The controller 100 checks whether a FAX is received (step S102). Specifically, the controller 100 checks, based on a communication history, whether the FAX controller 102 has received. an image (received an image by facsimile communication) via a communicator (for example, the line communicator 140). Alternatively, the controller 100 may check whether the FAX has been received, by acquiring information whether the received image is stored in the received image data 116.

If the FAX has been received (step S102; Yes), the controller 100 generates communication information (step S104).

The controller 100 transmits an image received by facsimile communication and communication information corresponding to the image to the server device 20 (step S106). That is, the image communication device 10 generates a message and posts the message in the server device 20. The server device 20 may receive communication information and the like from the image communication device 10, generate a message based on the communication information and the like, and post a message indicating that the FAX has been received on the timeline.

The message includes information based on the communication information (for example, information about the sender such as a name and a telephone number of the sender, an image size, a number of received sheets, and the like). The controller 100 may include, in the message, information of the image communication device 10 that actually receives the FAX (for example, a name, IP address, FAX number, and the like of the image communication device 10).

If receiving a reply command from the terminal device 30 via the server device 20 (step S108; Yes), the controller 100 generates reply data based on the reply command (step S110). The reply data includes at least a reply image and information representing the transmission source (for example, a telephone number of the sender).

As a method for identifying the transmission source, the controller 100 may utilize, for example, identification information of the sender acquired from a protocol (for example, a TSI or the like in the case of the G3 protocol), or a FAX number transmitted from a telephone line of the transmission source. Alternatively, the controller 100 may recognize characters in the image data to recognize information on the sender.

The image communication device 10 transmits a FAX based on the reply data (step S112). Specifically, the FAX controller 102 transmits a reply image to the information representing the transmission source (for example, a FAX number) by facsimile communication.

Here, if the FAX transmission is successful (that is, if the image transmission to the image communication device of the transmission source is completed without an error), the controller 100 may check-mark the FAX as replied (step S114; Yes->step S116).

If the FAX transmission fails (that is, if the reply image cannot be transmitted to the image communication device of the transmission source), the controller 100 may execute an error process (step S118).

Here, the processes described below can be considered as the error process executed by the controller 100.
If a job of a FAX transmission to which a reply is transmitted fails due to an error such as a transmission destination being busy, retransmission is performed automatically after a certain time
If retransmission is performed, as to a time when to perform retransmission, a time period in which FAX transmission is likely to succeed are learned for each transmission destination from the history of FAX transmission and reception, and retransmission is performed at that time

In the process described above, the user performs the reply operation. However, the system 1 may be caused to learn to execute a process for prompting a reply. For example, if the reply process is executed for an image received by FAX, a learning content may include whether a reply is transmitted to a content of the image and the transmission destination. Then, a content and a transmission source of an image received afterwards are compared with the learning result, and if it is determined that the FAX reception requires a reply and a reply process is not yet executed for the FAX reception, the user may be prompted to reply by a push notification or the like.

### 2.1.2 Terminal Device

An operation of the terminal device 30 will be described with reference to FIG. 10. First, before the start of the process in FIG. 10, the controller 300 (timeline processor 302) displays the timeline on the display 335 in the terminal device 30.

The timeline processor 302 may display the timeline by executing a dedicated application, or may connect to an external chat server to display the timeline.

The timeline processor 302 displays a message including communication information of the transmission source and a thumbnail image on the timeline (step S152). The messages are displayed if the image communication device 10 receives a FAX.

If a message including the communication information of the transmission source and the thumbnail image is displayed on the timeline, the timeline processor 302 further displays a selection button on the timeline (step S154). If a selection button for executing a reply process is selected by the user (step S156; Yes->step S158; Yes), the controller 300 transmits a reply command to the image communication device 10 (step S160).

If another selection button is selected by the user, the controller 300 executes a process corresponding to the selection button (step S156; Yes->step S158; No->step S162).

For example, the processes described below can be considered as the process in a case where the other selection button is selected.

### (1) “Preview”

The controller 300 displays the received image. Typically, a small thumbnail image is displayed in a first message, and thus, the controller 300 displays a preview of an image having a size larger than the thumbnail image.

### (2) “Forward to Email”

The controller 300 transfers by email the image received by the image communication device 10 by FAX. In this case, the received image is attached to an email, and the controller 300 transmits the email to a designated transmission destination. The transmission destination may be any destination or may be a destination set in advance. The controller 300 may perform transmission to a user who is logged in to the system by user authentication.

Subsequently, the list button B106 is displayed on the display screen displayed on the display 335 of the terminal device 30. If the list button B106 is selected by the user (step S164; Yes), a list display process is executed (step S166).

### 2.2 Operation Example (List Display Process)

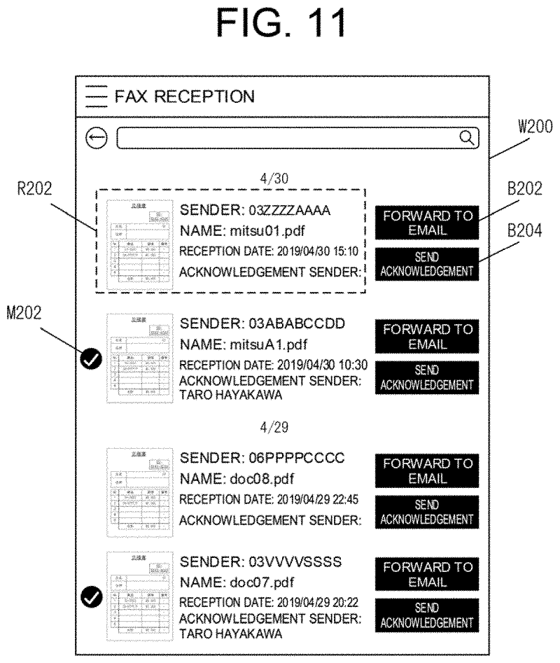

Here, the list display process executed in step S166 is a process of displaying, in the terminal device 30, a list of images received by the facsimile communication in the image communication device 10. FIG. 11 is an example of a display screen W200 displayed in the terminal device 30 if the list display process is executed.

If the user selects a list button, the controller 300 of the terminal device 30 acquires the history of the received image (FAX) from the image communication device 10 and displays the history in a list. Specifically, the terminal device 30 transmits a request for acquiring history information to the image communication device 10. At this time, the terminal device 30 may directly make a request with respect to the image communication device 10, or may make a request via the server device 20.

If receiving a request for history acquisition from the terminal device 30 (server device 20), the image communication device 10 (controller 100) refers to the history data 114 and transmits the history information of the received image to the terminal device 30.

The terminal device 30 displays a list based on the acquired history information. For example, in the display screen W200, a thumbnail image of the received image and communication information (for example, a sender, name, reception date, acknowledgement sender, and the like) are displayed in a region R202 for each received FAX by date.

The terminal device 30 may also display a selection button at this time. For example, a selection button such as a selection button B202 and a selection button B204 is displayed for each FAX reception history being displayed. Accordingly, if the user selects a button, the terminal device 30 executes a process of the selected button for each image.

At this time, a plurality of FAX reception histories may be selected by a selection operation of the user. The terminal device 30 is capable of collectively performing an operation for the selected FAX reception histories. As a result, the controller 300 is capable of collectively executing reply processes for received FAX items for which a reply operation is not performed, for example.

Further, when displaying the list, the controller 300 may check whether a reply is transmitted for the received FAX and display the result. For example, a mark M202 indicates that a reply is transmitted for the reception history of the FAX.

As described above, according to the present embodiment, the terminal device 30 can display a list of FAX items received by the image communication device 10. By checking the FAX reception history displayed in the list, the user can easily check whether the reply process for the received FAX has been executed. Further, the user can transmit by a simple operation a reply to the reception of a FAX for which no reply is yet transmitted.

### 3. Third Embodiment

A third embodiment will be described. In the first embodiment and the second embodiment, a reply operation is performed with respect to the transmission source. However, in the third embodiment, a reply destination is selected. The system configuration and the like are the same as those in the first embodiment, and in the present embodiment, differences from the first embodiment will be mainly described.

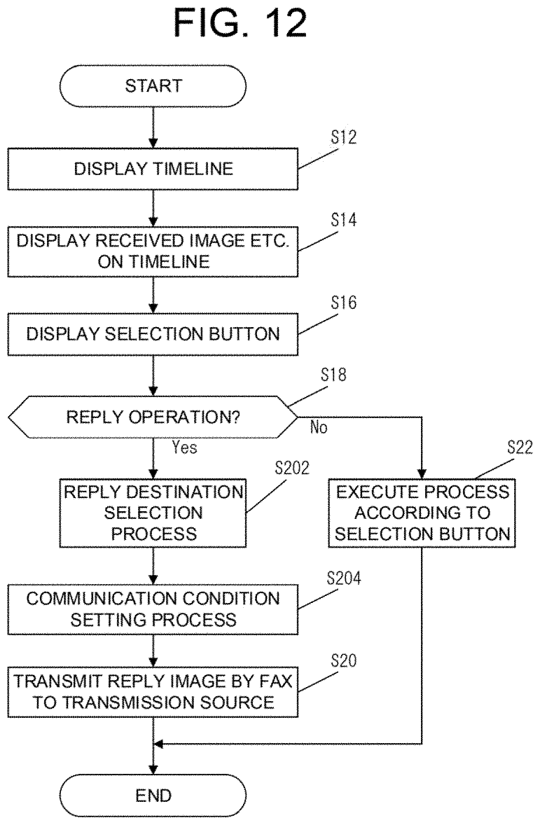

FIG. 12 is a process flow in the present embodiment, and is a process in which FIG. 5 of the first embodiment is rearranged. The same processes are denoted by the same reference numerals. That is, in FIG. 12, processes different from those in FIG. 5 are steps S202 and S204.

If the user performs a reply operation (step S18; Yes), the controller 300 executes a reply destination selection process (step S202). The reply destination selection process is a process of selecting information (a destination) of a transmission target of a reply image.

For example, the controller 300 causes the user to select a reply destination (transmission destination) from an address book stored in any one of the image communication device 10, the server device 20, and the terminal device 30. The controller 300 causes the user to directly input identification information (an identification number) such as a telephone number (FAX number), an IP address, and an email address, and sets the input identification information as the reply destination (transmission destination).

Further, the controller 300 executes a communication condition setting process (step S204). The communication condition setting process is a process of setting a condition during the transmission of the reply image. For example, if a plurality of the image communication devices 10 are connected to the system 1, an image communication device that transmits the reply image is set. The controller 300 may transmit a reply image to the image communication device 10 based on any image or text uploaded or input by the user.

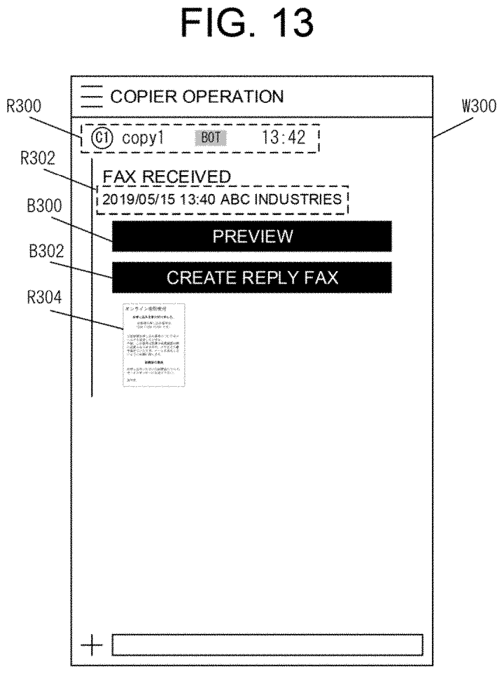

An example of a screen in the present embodiment will be described with reference to the drawings. FIG. 13 is an example of a display screen W300 that displays a timeline in the terminal device 30 in the present embodiment. In the timeline, the terminal device 30 displays information of the image communication device 10 as a poster of the message in a region R300 and information about the sender of the FAX (communication information) in a region R302. The terminal device 30 also displays a selection button B300 and a selection button B302 on the timeline, and displays a thumbnail image of the received image (for example, only one page being a cover page) in a region R304.

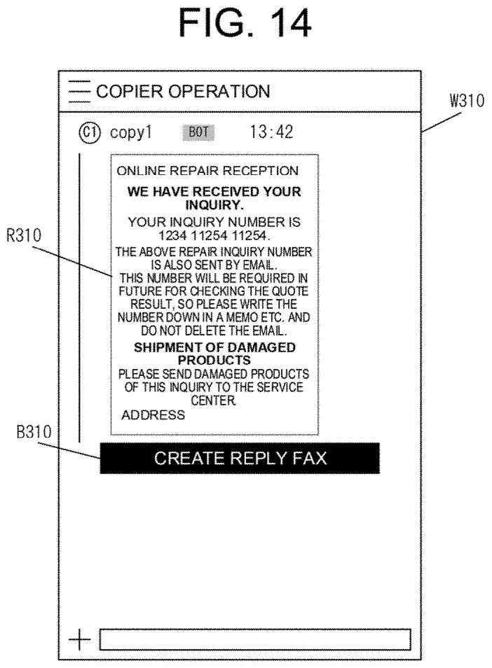

Here, if the selection button B300 is selected by the user, a preview image is displayed in a region R310 as illustrated in a display screen W310 in FIG. 14. The preview image is displayed in a larger size than the thumbnail image in FIG. 13, and the user can turn the page, for example.

The terminal device 30 displays a selection button B310 even after displaying the preview image. That is, the user can select a reply operation for the FAX at any timing.

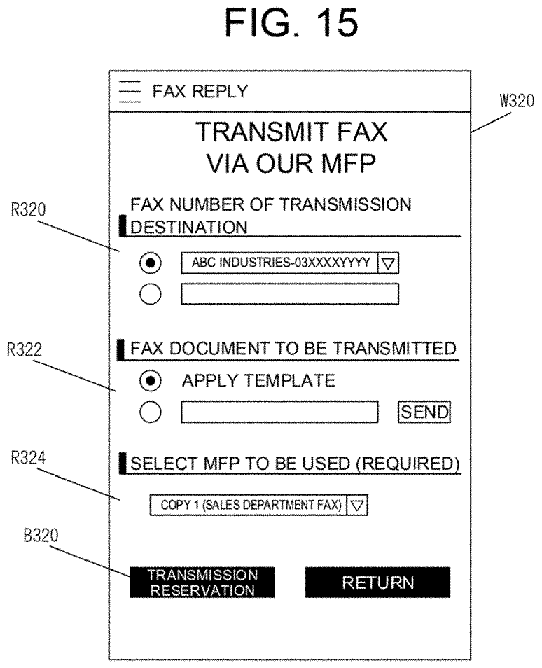

Here, if the selection button B302 of FIG. 13 or the selection button B310 of FIG. 14 is selected, the terminal device 30 executes a reply process. A display screen W320 in FIG. 15 is an example of a display screen for setting a transmission destination and a communication condition in this case.

The terminal device 30 causes the user to input the transmission destination in a region R320. In a region R322, the terminal device 30 causes the user to select or upload an image (reply image) to be transmitted. The terminal device 30 causes the user to select the image communication. device 10 that performs facsimile communication in a region R324.

Here, as the image communication device 10 selectable in the region R324, the image communication device 10 that receives the image is displayed by default, or the set image communication device 10 is displayed by default.

In addition, an image communication device connected to the network is detected and displayed, or an image communication device set manually is displayed.

If a selection button B320 is selected by the user, the terminal device 30 performs a FAX transmission reservation (reservation for transmitting a reply image by facsimile communication).

For convenience of description, description is given with reference to the single figure (i.e. FIG. 15), however, the user may be caused to switch the screen for each item and perform input, or may be caused to input only a necessary item. If the selection button B320 is selected, the terminal device 30 gives an instruction to the image communication device 10. The image communication device 10 may immediately transmit the image to the transmission destination by facsimile communication, may transmit the image after a predetermined time period, or may transmit the image at a predetermined timing.

A display size of the message can be switched on the timeline illustrated in FIG. 13. For example, the terminal device 30 is capable of switching a display format on the timeline to “large” (for example, one reception item on one screen), “medium” (for example, 2 to 3 reception items on one screen), and “small” (for example, 5 to 6 reception items on one screen in a list).

Further, the terminal device 30 is capable of switching whether to display the thumbnail image. As for the preview image, after only one page is displayed, the remaining pages may be downloaded, or all pages may be downloaded in advance.

If a transmission destination is input into the region R320, the terminal device 30 may synchronize the transmission destination with an address book of the image communication device 10 or the terminal device 30. For example, if a FAX number is newly input in the region R320, the image communication device 10 or the terminal device 30 may newly register the FAX number in the address book stored in the image communication device 10 or the terminal device 30. Further, if the FAX number is edited in the region R320, the image communication device 10 or the terminal device 30 may edit the FAX number in the address book stored in the image communication device 10 or the terminal device 30.

The terminal device 30 may set another condition in the communication condition setting process. For example, Modified Huffman (MH), Modified Read (MR), or Modified Read (MMR) may be selected as an image compression scheme during the transmission by the image communication device 10. The terminal device 30 may select whether the image communication device 10 adds sender information at the time of image transmission, or may set the sender information.

### 4. Fourth Embodiment

A fourth embodiment will be described. The fourth embodiment will describe a case where a transmission error occurs in the image communication device 10 and a reply image cannot be transmitted to the transmission destination.

In this case, the image communication device 10 posts a message to ask whether to perform a retransmission reservation, to the server device 20. Thus, the terminal device 30 displays on the timeline that the reply image cannot he transmitted. The terminal device 30 also displays, on the timeline, a selection button for selecting whether retransmission is to be performed.

If the user selects the button for retransmission, the terminal device 30 transmits a command for retransmission reservation to the image communication device 10. If receiving the command for retransmission reservation, the image communication device 10 executes the retransmission reservation for the reply image specified by the command.

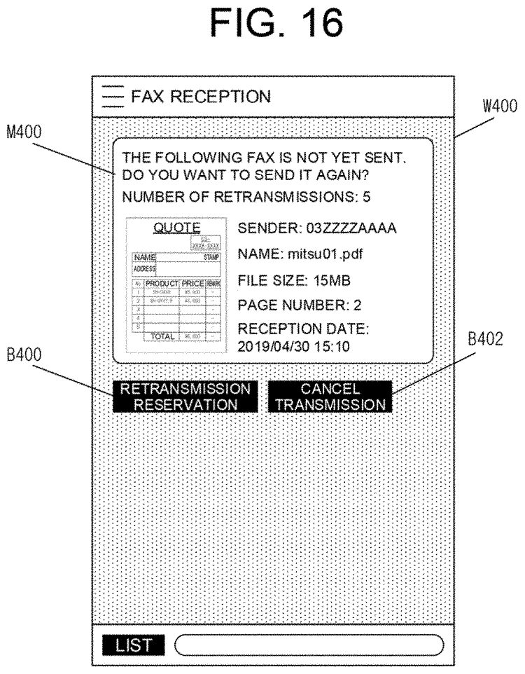

FIG. 16 illustrates an example of a display screen W400 of the terminal device 30 in the present embodiment. The terminal device 30 displays, on the timeline, a message indicating that the reply image is not yet transmitted in a message M400. In this message, the terminal device 30 may include communication information including the transmission destination and a thumbnail image of the image to be transmitted and display the message.

The terminal device 30 also displays a selection button B400 and a selection button B402 on the timeline. If the selection button B400 is selected by the user, the terminal device 30 executes retransmission reservation of the image that is not yet transmitted. If the selection button B402 is selected by the user, the terminal device 30 cancels the transmission of the image that is not yet transmitted.

As described above, according to the present embodiment, the user can confirm, on the timeline displayed in the terminal device 30, that an image is not yet transmitted from the image communication device 10 by the facsimile communication. Further, the user can instruct retransmission of an image that is not yet transmitted or transmission cancellation in the timeline.

If performing retransmission reservation, the terminal device 30 may transmit the image to a different transmission destination. For example, if a plurality of FAX numbers of transmission destinations are stored, the image communication device 10 may switch the FAX numbers sequentially to transmit the image. If transmission is not possible via the telephone line, the image communication device 10 may switch to the Internet FAX or to email transmission, for example.

### 5. Modification

The present invention is not limited to the above embodiments, and can have various modifications. That is, embodiments obtained by combining technical means appropriately changed within the scope not departing from the gist of the present invention are also included in the technical scope of the present invention.

Although the above-described embodiments have portions described separately for convenience of description, it is needless to say that the embodiments may be combined and executed within a technically possible range. As mentioned above, the embodiments described in the present specification can be combined and executed within a consistent range.

In addition, a program operating in each of the devices in the embodiments is a program (a program for making a computer function) that controls a CPU and the like to realize the functions of the above-described embodiments. Information processed by these devices is temporarily stored in a temporary storage device (such as a RAM) at the time of processing the information, and then stored in storage devices such as various types of ROMs, HDDs, and SSDs, and read, or corrected/written by the CPU as necessary.

If the program is distributed to a market, the program may be stored in a portable storage medium to be distributed, or the program may be transferred to a server computer connected via a network such as the Internet. In this case, of course, a storage device of the server computer is also included in the present invention.

### DESCRIPTION OF REFERENCE NUMERALS

1 System

10 Image communication device

100 Controller

102 FAX controller

104 Image processor

106 User manager

110 Storage

112 User information

114 History data

116 Received image data

118 Reply image data

120 Image reader

125 Image former

130 Inputter

135 Display

140 Line communicator

150 NW communicator

20 Server device

200 Controller

202 Timeline processor

204 User manager

210 Storage

212 Timeline data

214 Image data

216 User information DB

250 NW communicator

30 Terminal device

300 Controller

302 Timeline processor

304 Image processor

310 Storage

312 Timeline data

314 Image data

316 User information

330 Inputter

335 Display

350 NW communicator

What is claimed is:

1. A system comprising:
an image communication device that transmits and receives an image;
a server device that communicates with the image communication device; and
a terminal device that communicates with the server device, wherein the image communication device
transmits, to the server device, a first image based on a received image and communication information at a time when the image is received,
the terminal device:
receives the first image and the communication information from the server device;
displays the first image together with the communication information; and
transmits a reply command to the server device, based on an operation of a user, and
the image communication device transmits a second image to a destination included in the communication information, if the image communication device receives the reply command from the server device.

2. The system according to claim 1, wherein
the terminal device displays a timeline that displays messages in a chronological order, and displays the first image together with the communication information on the timeline.

3. The system according to claim 2, wherein
the terminal device displays, on the timeline, a thumbnail image being a reduced image of the first image.

4. The system according to claim 2, wherein
a button is displayed on the timeline, and
the terminal device transmits a reply command to the server device if the button is selected.

5. The system according to claim 1, wherein
the terminal device
acquires history information of the image received from the image communication device, and
displays, in a list display, the first image based on the received image and communication information at a time when the image is received for each reception, based on the history information.

6. The system according to claim 5, wherein
the history information includes information indicating reply is transmitted, and
the terminal device displays the list display together with identification information indicating that the reply is transmitted.

7. The system according to claim 1, wherein
the second image includes at least the first image.

8. An image communication device connectable to a server device that communicates with a terminal device, the image communication device comprising:
a first communicator that transmits, to the server device, a first image based on a received image and communication information at a time when the image is received; and
a second communicator that transmits a second image to a destination included in the communication information, if a reply command transmitted from the terminal device to the server device is received from the server device.

9. A communication method of an image communication device connectable to a server device that communicates with a terminal device, the communication method comprising:
transmitting, to the server device, a first image based on a received image and communication information at a time when the image is received; and
transmitting a second image to a destination included in the communication information, if a reply command transmitted from the terminal device to the server device is received from the server device.
